(19) United States
(12) Patent Application Publication
(10) Pub. No.: US 2008/0084318 A1
(43) Pub. Date: Apr. 10, 2008

(54) POOL INTRUSION DETECTION DEVICE AND METHOD

(76) Inventors: David Fogelson, Scottsdale, AZ (US); Joe J. Valancia, Phoenix, AZ (US)

Correspondence Address: WEISS & MOY PC, 4204 NORTH BROWN AVENUE, SCOTTSDALE, AZ, 85251, US

(21) Appl. No.: 11/867,472

(22) Filed: Oct. 4, 2007

Related U.S. Application Data
(60) Provisional application No. 60/828,349, filed on Oct. 5, 2006.

(51) Int. Cl. G08B 21/08

(52) U.S. Cl. 340/573.6

(57) ABSTRACT

A sub-surface laser scanning device is disclosed. The device employs laser pulses to scan an entire area of a swimming pool and uses that scan to constantly compare to current conditions in the pool in order to determine if a person has actually submerged below the surface of the pool. Entry of an object or person in the pool disrupts the laser pulses and triggers an alarm. The device may be set up to detect pool equipment and other common pool items, in order to avoid triggering false alarms.

### RELATED APPLICATION

This non-provisional application claims the benefit of U.S. Provisional Application No. 60/828,349, filed on Oct. 5, 2006.

### FIELD OF THE INVENTION

This invention relates generally to pool entry detection devices and methods and, more particularly, to a sub-surface laser scanning device for detecting pool entry and method therefor.

### BACKGROUND OF THE INVENTION

Approximately 350 children under the age of five drown each year in swimming pools, according to the U.S. Consumer Product Safety Commission. In addition, another 2,600 children under the age of five are treated in hospital emergency rooms for submersion related accidents. Many prior art devices attempt to address pool safety, from pool fences to motion detectors to pool alarms. Because pool fences can often be breached or accidentally left open, many prior art devices are directed to intrusion systems that set off an alarm when the pool surface is interrupted.

For example, U.S. Pat. No. 6,278,373 B1 issued to Jaurigue et al. discloses a laser intrusion system for detecting motion in a swimming pool. The laser in the Jaurigue et al. patent is mounted above the surface of the pool. It is often the case, however, that objects, such as foliage debris, rafts, or pool toys inadvertently come into contact with the surface of the pool, setting off the alarm. Each false alarm decreases the effectiveness of a pool entry detection system, since it increases the likelihood that a true alarm may be ignored or reacted to in a less than urgent manner.

Several patent application publications are directed to sub-surface detection devices. U.S. Patent Application Publication 2005/0258968 A1 listing inventor Philippe et al. discloses a sub-surface detection device designed to measure the gravitational waves generated by a body falling into a pool. Similarly, U.S. Patent Application Publication 2005/0093706 A1 listing inventor Hoenig discloses a hydrophone that is used to detect sound pressure waves below the surface of the pool. Sub-surface wave detection, however, may not be entirely accurate, due to the fact that false alarms may be generated by such things as a paddling duck and blowing debris impacting the surface of the pool. In addition, it may be possible that a child entering the pool gingerly may not set off such an alarm.

The present invention is directed to a sub-surface, laser scanning device for detecting pool entry and method therefor capable of scanning an entire area of a pool and then using that scan to constantly compare to current conditions in order to determine if a person has actually submerged below the surface of a pool.

### SUMMARY OF THE INVENTION

In accordance with one embodiment of the present invention, a sub-surface laser scanning device is disclosed. The device comprises, in combination: a laser element positioned below a surface of water in a pool and adapted to emit laser pulses to generate a plane of detection of an area of the pool; a photo detector module; a PC board adapted to direct the laser element and photo detector module to scan the area of the pool; a containment case adapted to house the laser element, photo detector module, and PC board, wherein the containment case is adapted to be positioned below a surface of water in the pool; and an alarm adapted to sound upon an object entering the pool and crossing the plane of detection.

In accordance with another embodiment of the present invention, a sub-surface laser scanning device is disclosed. The device comprises, in combination: a laser element positioned below a surface of water in a pool and adapted to emit laser pulses to generate a plane of detection of an area of the pool; a photo detector module adapted to condition ambient light to permit only a specific laser wavelength; a PC board having a memory, wherein the PC board is adapted to: direct the laser element and photo detector module to scan the area of the pool; and analyze reflected photonic energy to generate a specific profile of the area of the pool, wherein the profile is adapted to be used for comparison when the sub-surface laser scanning device is in an active scanning mode; a containment case adapted to house the laser element, photo detector module, and PC board, wherein the containment case is adapted to be positioned below a surface of water in the pool; and an alarm adapted to sound upon an object entering the pool and crossing the plane of detection; wherein the sub-surface laser scanning device is adapted to avoid false alarms by employing algorithms to factor out signals from conventional pool elements.

In accordance with a further embodiment of the present invention, a method for detecting entry of objects in a pool is disclosed. The method comprises the steps of: providing a sub-surface laser scanning device comprising, in combination: a laser element positioned below a surface of water in a pool and adapted to emit laser pulses to generate a plane of detection of an area of the pool; a photo detector module; a PC board adapted to direct the laser element and photo detector module to scan the area of the pool; a containment case adapted to house the laser element, photo detector module, and PC board, wherein the containment case is adapted to be positioned below a surface of water in the pool; and an alarm adapted to sound upon an object entering the pool and crossing the plane of detection; installing the sub-surface laser scanning device below the surface of the water in the pool; and permitting the sub-surface laser scanning device to scan the area of the pool for objects.

### BRIEF DESCRIPTION OF THE DRAWINGS

FIG. 1 is a top plan view of a sub-surface laser scanning device of the present invention, shown scanning the perimeter of a swimming pool.

FIG. 1a is a graphical representation of laser beams of the sub-surface laser scanning device of FIG. 1.

FIG. 2 is a top plan view of the sub-surface laser scanning device of FIG. 1, showing an alarm being sounded as a result of an object that breaks the beam of the laser.

FIG. 2a is a graphical representation of laser beams of the sub-surface laser scanning device of FIG. 2.

FIG. 3 is a block diagram of the sub-surface laser scanning device of the present invention.

FIG. 4 is a partially-exploded, perspective view of the sub-surface laser scanning device of the present invention.

### DETAILED DESCRIPTION OF THE PREFERRED EMBODIMENTS

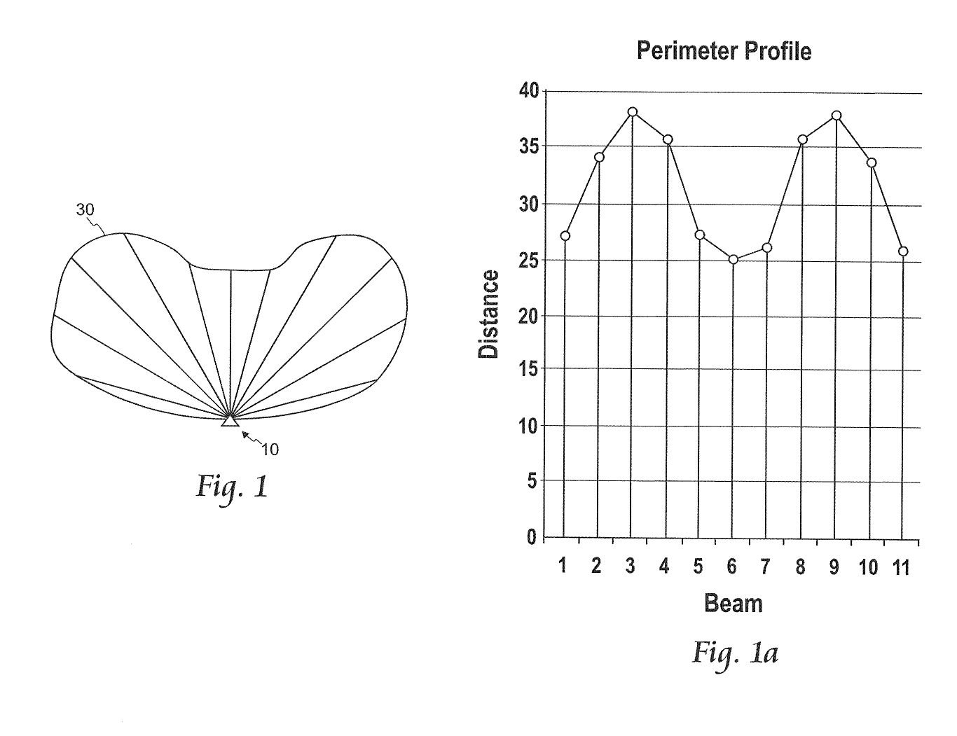

Referring to FIGS. 1, 2 and 4, a sub-surface laser scanning device 10 (“device 10”) consistent with an embodiment of the present invention is shown. The device 10 is placed below the surface of water in a pool in order to prevent surface events, such as wind or floating pool toys, from accidentally triggering an alarm 40. In the preferred embodiment, the device 10 is placed between approximately 8-14 inches below the surface of the water, although it should be clearly understood that substantial benefit could be derived from an alternative embodiment of the present invention in which the placement depth of the device 10 deviates, even substantially, from the preferred depth. For example, the device 10 may be placed as little as 1-2 inches below the surface of the water, or greater than 14 inches below the surface.

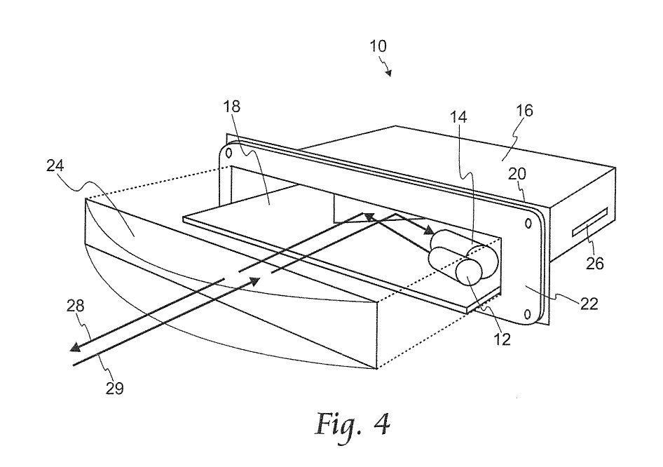

Referring now to FIG. 4, the main components of the device 10 are shown and include a laser element 12, a photo detector module 14, and a PC board or alarm scanning module compartment 18. The laser element 12, photo detector module 14, and PC board 18 are housed within a containment case 16. The containment case 16 is preferably sealed, in order to protect the internal components of the device 10 from environmental conditions. In this embodiment, a front portion of the containment case 16 includes a seal 20, a faceplate 22, and a window 24. The seal 20 is preferably situated between the containment case 16 and the faceplate 22, to help create a water-tight enclosure for the internal components of the device 10. The window 24 is preferably comprised of tempered, anti-scratch glass. A power and control panel harness connector 26 may be positioned on a side of the containment case 16. By way of the power and control harness connector 26, the device 10 may be connected to a stand alone control panel or integrated into an existing pool monitoring and management system.

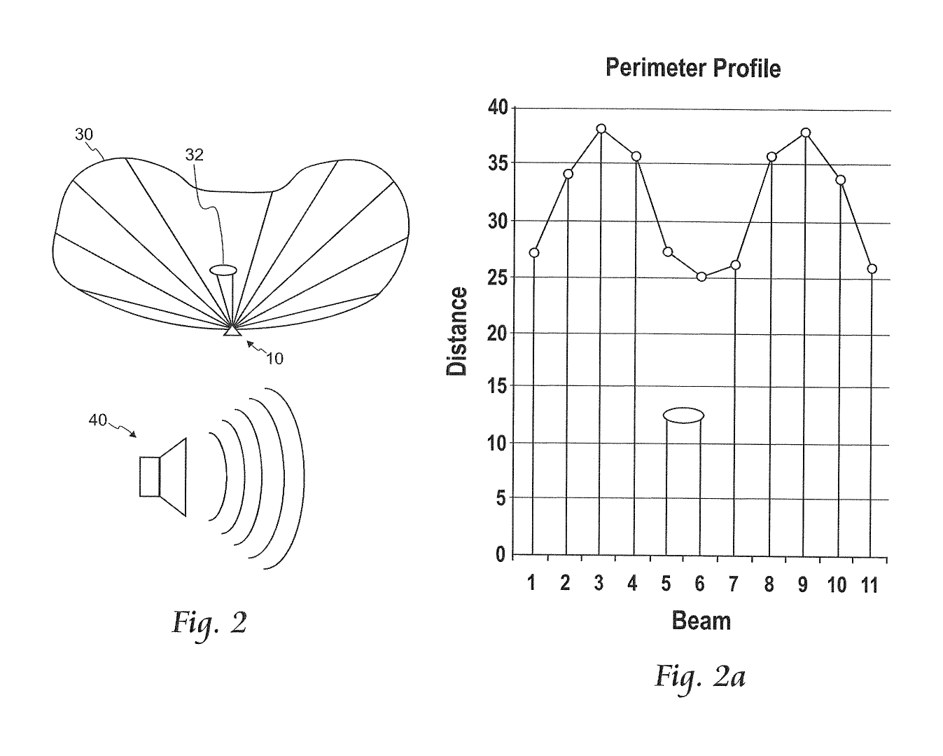

The PC board 18 directs the laser element 12 and photo detector module 14 to scan a perimeter of a pool 30 (as shown in FIGS. 1-2). The PC board 18 directs the laser element 12 to emit pulses (represented by outgoing arrows 24) across the pool 30 in order to generate a plane of detection. The photo detector module 14 conditions ambient light to permit only the specific laser wavelength. The reflected photonic energy (represented by incoming arrows 26) is then analyzed by the PC board 18 to generate a specific profile of the perimeter of the pool 30. By way of example, a graphical representation of such a perimeter profile is illustrated in FIG. 1a. The specific profile of the perimeter of the pool 30 is preferably stored in the memory of the PC board 18 and is used for comparison when the device 10 is in active scanning mode.

Referring now to FIG. 2, any object 32 that crosses the plane of the laser pulses creates an altered perimeter value. In one embodiment, the detection of an altered perimeter value will trigger an immediate alarm 40 to notify those within reasonable proximity of the pool 30 to investigate. By way of example, a graphical representation of an altered perimeter value is illustrated in FIG. 2a. Due to the common use of pool cleaning equipment, especially such equipment that utilizes hosing, the device 10 preferably first compares the altered perimeter value to a profile of pool cleaning equipment to determine if the altered perimeter value exceeds the tolerances of the pool cleaning equipment profile, which would then trigger the alarm.

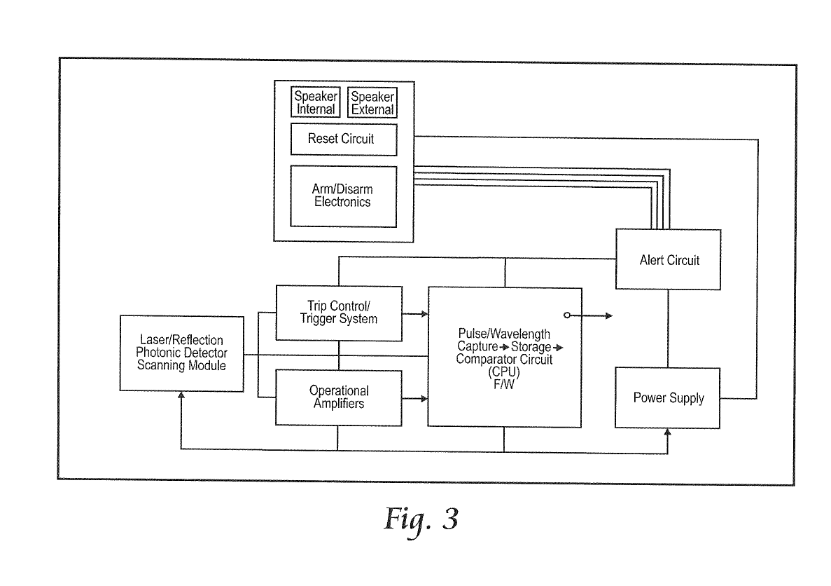

Referring now to FIG. 3, a block diagram is shown depicting the top-level functionality of the device 10. The photonic detector module 14 scans the perimeter of the pool 30 and reconditions the spectrum of natural light and filtered photonic light intensity emitted by the laser diode circuitry. Filters are used to condition the laser wavelength and isolate the phototransistor sensitivity to photonic energy from the laser element 12 as the laser beam meets the different media boundaries (e.g., water, pool surface walls, etc.). Variations in wavelengths or pulses are used to measure the perimeter (or other defined area) of the pool 30. Preferably, wavelengths/pulses are captured in the form of signal waveforms and stored using a capture (i.e. store) comparator circuitry designed to compare every scan to a stored profile. Once the profile has been stored, any variation registered by the comparator circuit (which is preferably embodied in a CPU and firmware) will enable the trip system and trigger the alarm.

In the preferred embodiment, a trip control and amplification circuit tunes up the current gain required to activate alert circuitry. The system is then armed with a programmed self test which activates the scanning module and runs several passes at the perimeter of the pool while the pool has no activity. If the perimeter of the pool is not free of obstruction during this stage, then an arm/disarm system will preferably alert the user through sound and LED indicators that there is some level of intrusion in the areas being scanned and the system will fail to get armed. Any disruption to the self test's scan rate during this phase will fail to arm the system and will notify the user that the alarm system is not set.

In an alternative embodiment of the present invention, the device 10 uses special algorithms to factor out signals from most conventional pool elements and/or devices that form part of most conventional pool decorative and self-cleaning mechanisms or systems in order to avoid false alarms. Preferably, the device 10 can be integrated into existing pool monitoring and management systems. The device 10 preferably includes a control panel (if installed independently) and is designed in a self contained sealed and insulated system to protect against environmental conditions and electronic operating requirements (see FIG. 4). In the preferred embodiment, conventional 120-220 VAC power is reconditioned to handle the system components' low-voltage requirements.

While the invention has been particularly shown and described with reference to the preferred embodiments thereof, it will be understood by those skilled in the art that the foregoing and other changes in form and details may be made therein without departing from the spirit and scope of the invention. For example, while in the preferred embodiment, the device 10 includes circuitry designed to filter out pool equipment, it should be clearly understood that substantial benefit could be derived from an alternative embodiment of the present invention in which there is no such filter, or in which objects other than pool equipment are filtered out.

I claim:

1. A sub-surface laser scanning device comprising, in combination:
a laser element positioned below a surface of water in a pool and adapted to emit laser pulses to generate a plane of detection of an area of the pool;
a photo detector module;
a PC board adapted to direct the laser element and photo detector module to scan the area of the pool;
a containment case adapted to house the laser element, photo detector module, and PC board, wherein the containment case is adapted to be positioned below a surface of water in the pool; and
an alarm adapted to sound upon an object entering the pool and crossing the plane of detection.

2. The sub-surface laser scanning device of claim 1 wherein the photo detector module is adapted to condition ambient light to permit only a specific laser wavelength.

3. The sub-surface laser scanning device of claim 2 wherein:
the PC board is further adapted to analyze reflected photonic energy to generate a specific profile of the area of the pool; and
a memory of the PC board is adapted to store the profile.

4. The sub-surface laser scanning device of claim 3 wherein the profile is adapted to be used for comparison when the sub-surface laser scanning device is in an active scanning mode.

5. The sub-surface laser scanning device of claim 1 adapted to avoid false alarms by employing algorithms to factor out signals from conventional pool elements.

6. The sub-surface laser scanning device of claim 1 further comprising a window in the containment case.

7. The sub-surface laser scanning device of claim 1 wherein the containment case is positioned between approximately 8 to 14 inches below the surface of the water.

8. The sub-surface laser scanning device of claim 1 wherein the containment case is positioned between approximately 1 to 2 inches below the surface of the water.

9. A sub-surface laser scanning device comprising, in combination:
a laser element positioned below a surface of water in a pool and adapted to emit laser pulses to generate a plane of detection of an area of the pool;
a photo detector module adapted to condition ambient light to permit only a specific laser wavelength;
a PC board having a memory, wherein the PC board is adapted to:
direct the laser element and photo detector module to scan the area of the pool; and
analyze reflected photonic energy to generate a specific profile of the area of the pool, wherein the profile is adapted to be used for comparison when the sub-surface laser scanning device is in an active scanning mode;
a containment case adapted to house the laser element, photo detector module, and PC board, wherein the containment case is adapted to be positioned below a surface of water in the pool; and
an alarm adapted to sound upon an object entering the pool and crossing the plane of detection;
wherein the sub-surface laser scanning device is adapted to avoid false alarms by employing algorithms to factor out signals from conventional pool elements.

10. The sub-surface laser scanning device of claim 9 further comprising a window in the containment case.

11. The sub-surface laser scanning device of claim 9 wherein the containment case is positioned between approximately 8 to 14 inches below the surface of the water.

12. The sub-surface laser scanning device of claim 9 wherein the containment case is positioned between approximately 1 to 2 inches below the surface of the water.

13. A method for detecting entry of objects into a pool comprising the steps of:
providing a sub-surface laser scanning device comprising, in combination:
a laser element positioned below a surface of water in a pool and adapted to emit laser pulses to generate a plane of detection of an area of the pool;
a photo detector module;
a PC board adapted to direct the laser element and photo detector module to scan the area of the pool;
a containment case adapted to house the laser element, photo detector module, and PC board, wherein the containment case is adapted to be positioned below a surface of water in the pool; and
an alarm adapted to sound upon an object entering the pool and crossing the plane of detection;
installing the sub-surface laser scanning device below the surface of the water in the pool; and
permitting the sub-surface laser scanning device to scan the area of the pool for objects.

14. The method of claim 13 wherein the photo detector module is adapted to condition ambient light to permit only a specific laser wavelength.

15. The method of claim 14 wherein:
the PC board is further adapted to analyze reflected photonic energy to generate a specific profile of the area of the pool; and
a memory of the PC board is adapted to store the profile.

16. The method of claim 15 wherein the profile is adapted to be used for comparison when the sub-surface laser scanning device is in an active scanning mode.

17. The method of claim 13 wherein the sub-surface laser scanning device is adapted to avoid false alarms by employing algorithms to factor out signals from conventional pool elements.

18. The method of claim 13 wherein the sub-surface laser scanning device further comprises a window in the containment case.

19. The method of claim 13 wherein the containment case is positioned between approximately 8 to 14 inches below the surface of the water.

20. The method of claim 13 wherein the containment case is positioned between approximately 1 to 2 inches below the surface of the water.
